(19) United States
(12) Patent Application Publication
(10) Pub. No.: US 2026/0309180 A1
(43) Pub. Date: Oct. 8, 2026

(54) Load Bearing Shaft Connector

(71) Applicants: Christopher Andrew Plate, Cape Coral, FL (US); Matthew Royston, Fort Myers, FL (US); Chad Allen Flint, Fort Myers, FL (US)

(72) Inventors: Christopher Andrew Plate, Cape Coral, FL (US); Matthew Royston, Fort Myers, FL (US); Chad Allen Flint, Fort Myers, FL (US)

(21) Appl. No.: 19/171,341

(22) Filed: Apr. 6, 2025

(51) Int. Cl. F16B 29/00; E02D 5/54

(52) U.S. Cl. CPC F16B 29/00; E02D 5/54

(57) ABSTRACT

A load-bearing shaft connector configured to engage a shaft having an inner surface, a shaft longitudinal axis, and at least one shaft opening. The shaft connector comprises at least one engagement member, at least one expansion body, and at least one displacement body. Upon actuation of the engagement member, the expansion body and displacement body are drawn axially toward one another along the longitudinal axis of the shaft, and the expansion surface of the displacement body deforms the expansion body against the shaft inner surface, thereby securing the connector in place.

### BACKGROUND OF THE INVENTION

The present invention relates to apparatus and methods for the connection of shafts, and similar devices, and more particularly to load bearing shaft connectors for helical piles and similar structures.

### SUMMARY OF THE INVENTION

It is an object of the present invention to provide a load bearing shaft connector and method of using the same.

It is another object of the present invention to provide a shaft connector, and a method of using the same, that overcomes at least one deficiency in the prior art.

The present invention provides a shaft connector, and method of using the same, configured to engage a shaft having a shaft inner surface, a shaft longitudinal axis, and at least one shaft opening, with the shaft connector comprising an engagement member, an expansion body, and a displacement body.

In an exemplary embodiment of the present invention, the engagement member can include an engagement member first end and an engagement member second end, and can be configured to operably connect the expansion body and displacement body.

In an exemplary aspect, the expansion body can include an expansion body inner surface configured to accept at least a portion of the engagement member, an expansion body outer surface configured to be positioned at least partially within the shaft, an expansion body longitudinal axis, a first expansion body end, a second expansion body end, and an expansion body deformation surface positioned at the second expansion body end.

In another exemplary aspect, the displacement body can include a displacement body inner surface configured to accept at least a portion of the engagement member, a displacement body longitudinal axis, a displacement body first end configured to fit at least partially within the expansion body, a displacement body second end configured to fit at least partially within the shaft, and a displacement body expansion surface positioned between the displacement body first and second ends.

In still another exemplary aspect, the connector is configured such that, when the expansion body and displacement body are both positioned at least partially within the shaft, and the displacement body expansion surface is aligned with the expansion body deformation surface, actuation of the engagement member draws the expansion and displacement bodies toward each other, deforming the expansion body against the shaft inner surface and mechanically connecting the shaft connector to the shaft.

In another exemplary aspect, the shaft connector can be optionally configured with a loading body. The loading body can be positioned at the shaft open end, and optionally configured to contact the expansion body second end.

In further exemplary aspects, the shaft connector can be configured to engage shafts having circular, rectangular, square, and other cross-sectional inner surfaces, and can provide a mechanical connection thereto.

In another exemplary embodiment of the present invention, a method of using a load-bearing shaft connector to engage a shaft having an inner surface and at least one shaft opening can include the following steps: positioning the expansion body and displacement body at least partially within the shaft; aligning the displacement body expansion surface and the expansion body deformation surface; inserting the engagement member through the shaft opening to operably connect the expansion and displacement bodies; and actuating the engagement member to draw the components together such that the expansion body is deformed against the inner surface of the shaft, thereby securing the connector in place.

These and other exemplary aspects and embodiments of the present invention are further described herein.

### BRIEF DESCRIPTION OF DRAWINGS

FIG. 1A illustrates an exemplary assembled shaft connector installed in an exemplary shaft and positioned at the shaft opening.

FIG. 1B illustrates a detailed view of an exemplary assembled shaft connector installed in an exemplary shaft and positioned at the shaft opening.

FIG. 1C illustrates a cross-section assembly view of an exemplary shaft connector positioned partially within an exemplary shaft opening.

FIG. 1D illustrates a cross-section assembly view of an exemplary shaft connector positioned partially within an exemplary shaft opening, wherein the shaft connector is mechanically connected to the shaft via the deformation of the shaft connector expansion body to the shaft inner surface by the shaft connector displacement body.

FIG. 1E illustrates a cross-section detailed assembly view of an exemplary shaft connector positioned partially within an exemplary shaft, wherein the shaft connector is mechanically connected to the shaft via the deformation of the shaft connector expansion body to the shaft inner surface by the shaft connector displacement body.

FIG. 1F illustrates a cross-section detailed assembly view of an exemplary shaft connector positioned partially within an exemplary shaft, wherein the shaft connector is mechanically connected to the shaft via the deformation of the shaft connector expansion body to the shaft inner surface by the shaft connector displacement body and expansion surface of the displacement member is between the first and second ends of the expansion body.

FIG. 1G illustrates an exploded perspective view of an exemplary shaft connector in which a shaft connector includes an engagement member, optional engagement support member, an optionally configured loading body, an expansion member and a displacement member positioned over the open end of an exemplary shaft opening.

FIG. 2A illustrates a cross-section assembly view of an exemplary shaft connector positioned partially within an exemplary shaft opening, wherein the end of the shaft forming the shaft opening is cut at an angle.

FIG. 2B illustrates a cross-section assembly view of an exemplary shaft connector positioned partially within an exemplary shaft opening, wherein the end of the shaft forming the shaft opening is cut at an angle, and wherein the shaft connector is mechanically connected to the shaft via the deformation of the shaft connector expansion body to the shaft by the shaft connector displacement body.

FIG. 3A illustrates an isometric view of an exemplary assembled shaft connector installed in an exemplary shaft having a square shape and positioned at the shaft opening.

FIG. 3B illustrates a cross-section assembly view of an exemplary shaft connector configured to engage a shaft having a square shape and positioned partially within an exemplary shaft opening having a square shape.

FIG. 3C illustrates a cross-section assembly view of an exemplary shaft connector configured to engage a shaft having a square shape and positioned partially within an exemplary shaft opening, wherein the shaft connector is mechanically connected to the shaft via the deformation of the shaft connector expansion body to the shaft inner surface by the shaft connector displacement body.

FIG. 3D illustrates an exploded perspective view of an exemplary shaft connector configured to engage a shaft having a square shape, in which a shaft connector includes an engagement member, optional engagement support member, an optionally configured loading body comprised of a hollow square shape, an expansion member and a displacement member positioned over the open end of an exemplary shaft opening having a square shape.

FIG. 4A illustrates a cross-section assembly view of an exemplary shaft connector positioned partially within an exemplary shaft opening, wherein the shaft connector is comprised of two expansion bodies and two displacement bodies.

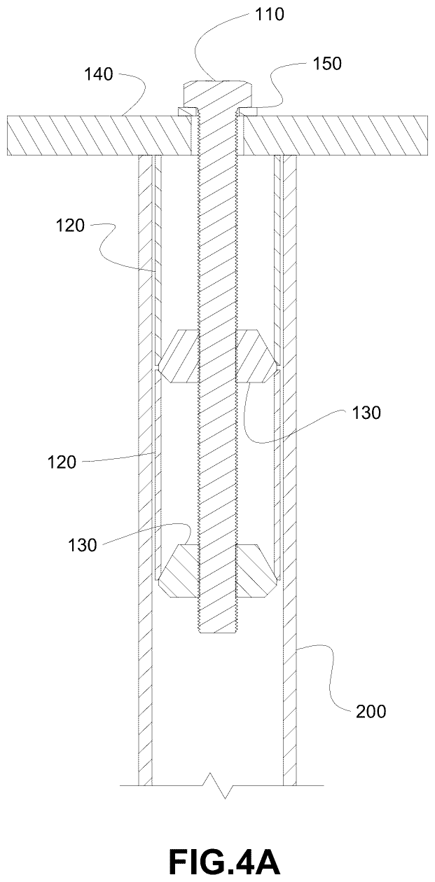

FIG. 4B illustrates a cross-section detailed assembly view of an exemplary shaft connector positioned partially within an exemplary shaft, wherein the shaft connector is comprised of two expansion bodies and two displacement bodies and wherein the shaft connector is mechanically connected to the shaft via the deformation of the shaft connector expansion bodies to the shaft inner surface by the shaft connector displacement bodies.

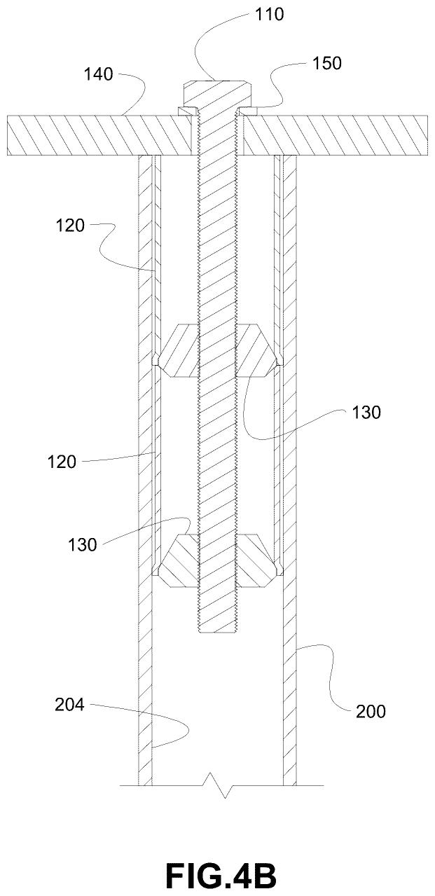

FIG. 5A illustrates multiple exemplary assembled shaft connectors installed in multiple exemplary shafts, and sharing a common loading body.

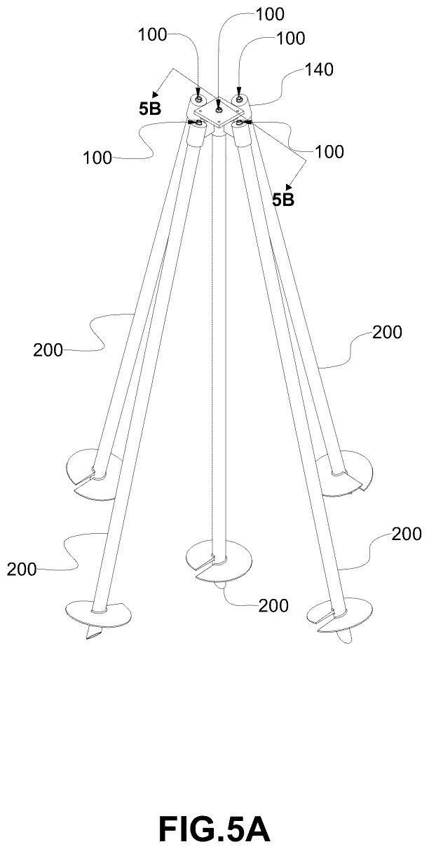

FIG. 5B illustrates a cross-section detailed assembly view of multiple exemplary shaft connectors positioned partially within multiple exemplary shafts, and sharing a common loading body, wherein the shaft connectors are in a non-engaged state.

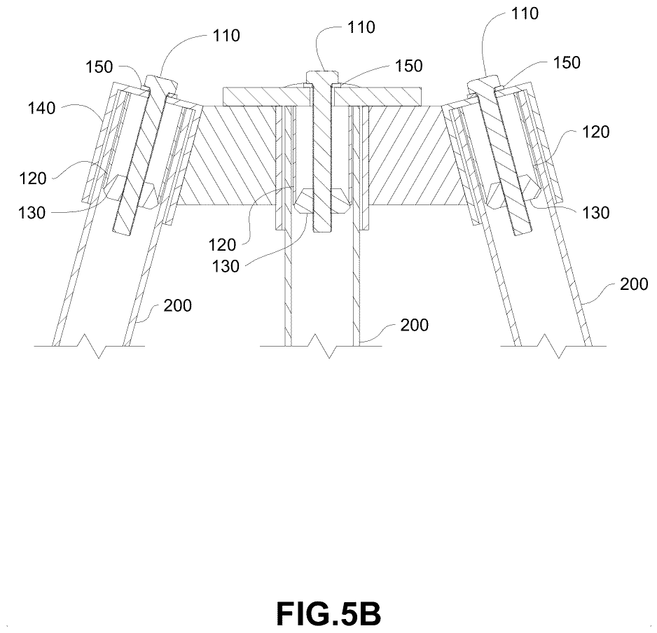

FIG. 6 illustrates exemplary method steps of using a shaft connector to connect to a shaft.

FIG. 7 illustrates exemplary engagement member.

FIG. 8 illustrates a cross-section view of an exemplary expansion body.

FIG. 9 illustrates a cross-section view of an exemplary displacement body.

FIG. 10 illustrates a cross-section view of another exemplary displacement body, wherein the displacement body further comprises a secondary engagement surface.

FIG. 11 illustrates a cross-section view of an exemplary shaft.

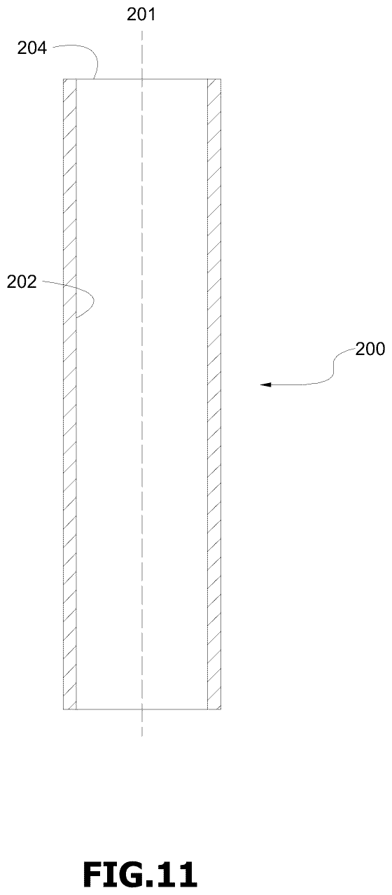

FIG. 12 illustrates a three-quarter cross-section isometric view of an exemplary shaft connector engaged to a shaft wherein the expansion body has engaged the circumference of the inner surface of the shaft and said engagement ring is on a plane that is perpendicular to the longitudinal axis of the shaft.

FIG. 13 illustrates a three-quarter cross-section isometric view of an exemplary shaft connector engaged to a shaft wherein the expansion body has engaged the circumference of the inner surface of the shaft, said engagement ring is on a plane that is perpendicular to the longitudinal axis of the shaft, and a portion of the loading body is within the shaft.

### DETAILED DESCRIPTION

It should be noted that this disclosure includes a plurality of embodiments, with a plurality of elements and aspects, and such elements and aspects need not necessarily be interpreted as being conjunctively required by one or more embodiments of the present invention. Rather, all combinations of the one or more elements and/or aspects can enable a separate embodiment of the present invention, which may be claimed with particularity in this or any one or more future filed Non-Provisional Patent Applications. Moreover, any particular materials, structures, and/or sizes disclosed herein, whether expressly or implicitly, are to be construed strictly as illustrative and enabling, and not necessarily limiting. Therefore, it is expressly set forth that such materials, structures, and/or sizes independently or in any combination thereof, are merely illustratively representative of one or more embodiments of the present invention and are not to be construed as necessary in a strict sense.

Further, to the extent the same element or aspect is defined differently within this disclosure, whether expressly or implicitly, the broader definition is to take absolute precedence, with the distinctions encompassed by the narrower definition to be strictly construed as optional.

Illustratively, perceived benefits of the present invention can include functional utility, whether expressly or implicitly stated herein, or apparent herefrom. However, it is expressly set forth that these benefits are not intended as exclusive. Therefore, any explicit, implicit, or apparent benefit from the disclosure herein is expressly deemed as applicable to the present invention.

According to the present invention, a shaft connector 100 can be formed from any one or more materials or combinations of materials, such as one or more of plastic, rubber, wood, metal, a crystalline material, or any other man-made or naturally occurring material, for example and not in limitation, insofar as the same is functionally consistent with the invention as described. Further, a shaft connector can be manufactured in any one or more functionally compatible manners, such as through molding, machining, additive processes, subtractive processes, etc.

Notably, the present invention includes particular structural aspects described herein that allow for attachment to a shaft, such as a helical piling shaft, for example and not in limitation.

According to the present invention, a load-bearing shaft connector 100 can be configured to engage a shaft 200 having a shaft inner surface 202, a shaft longitudinal axis 201, and at least one shaft opening 204 positioned along the shaft longitudinal axis.

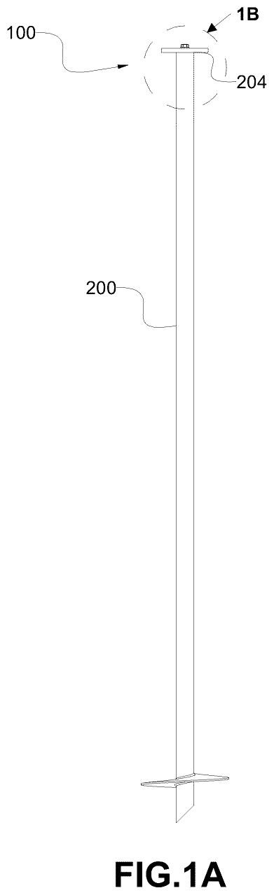

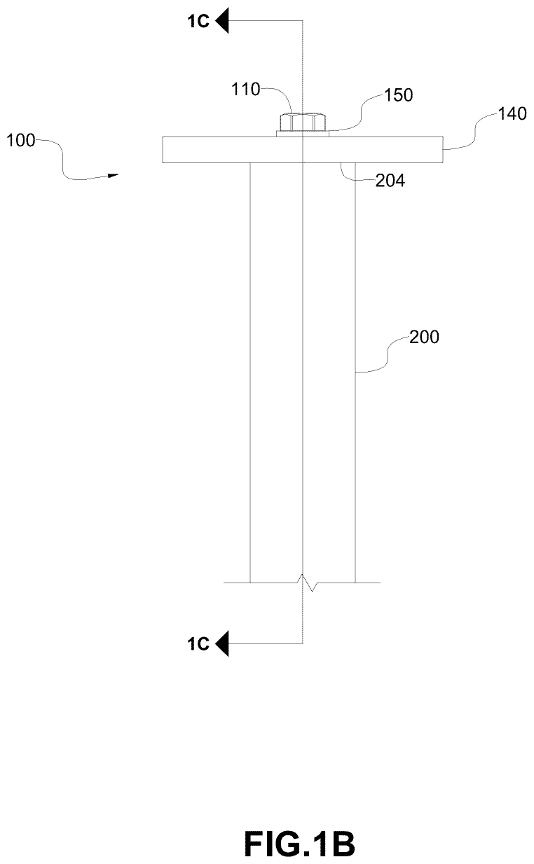

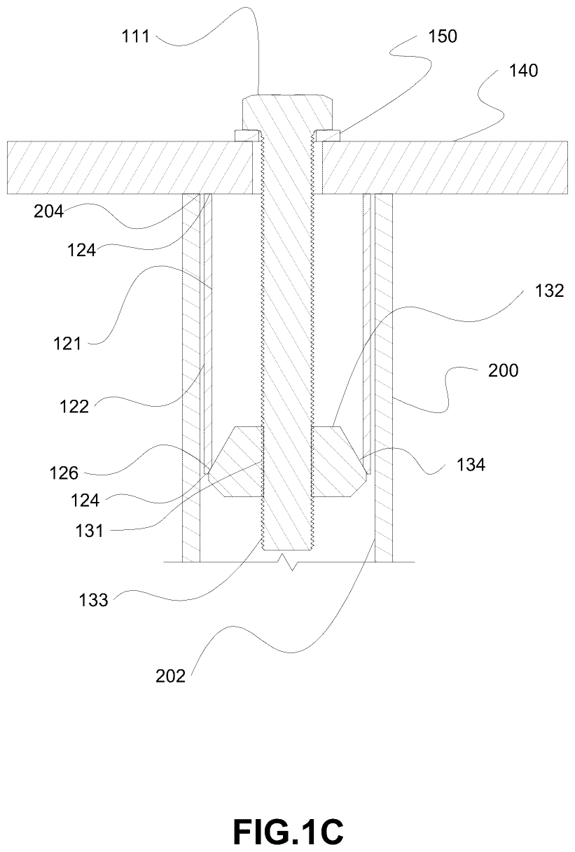

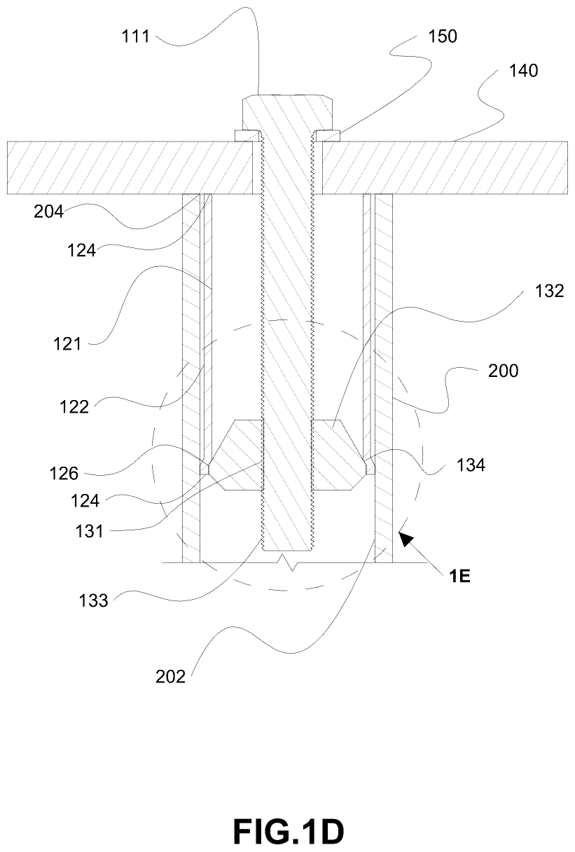

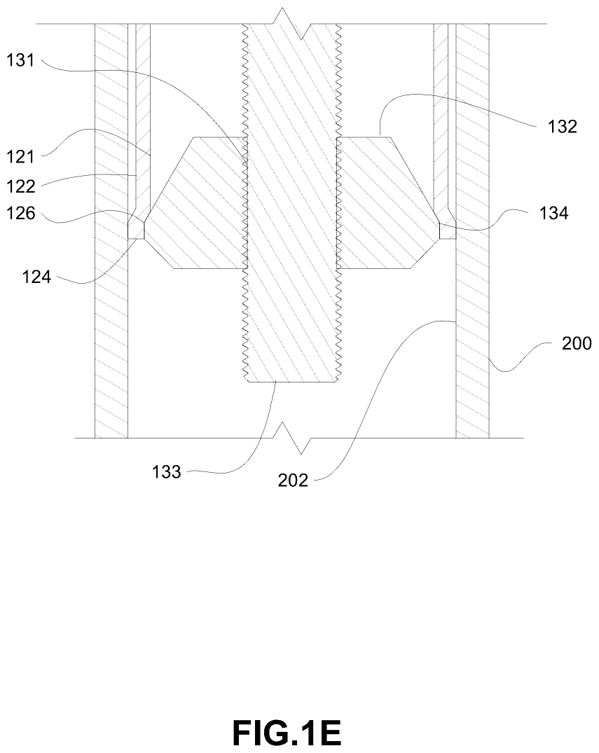

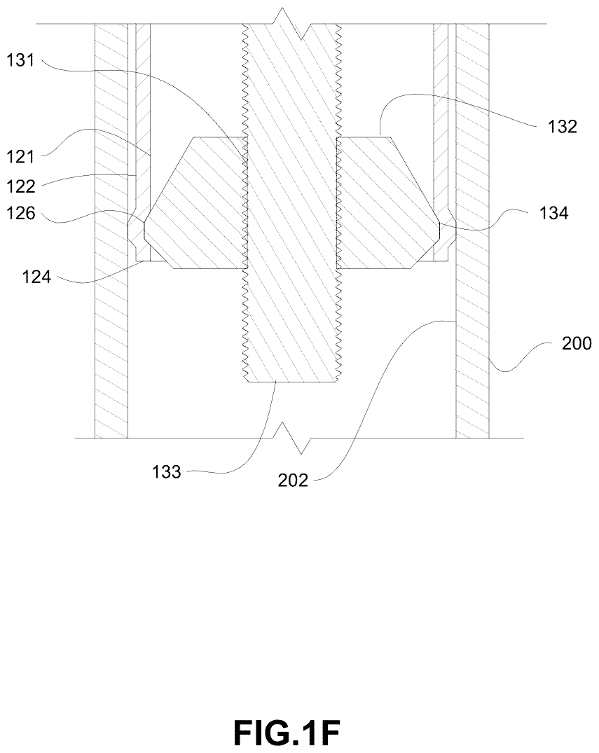

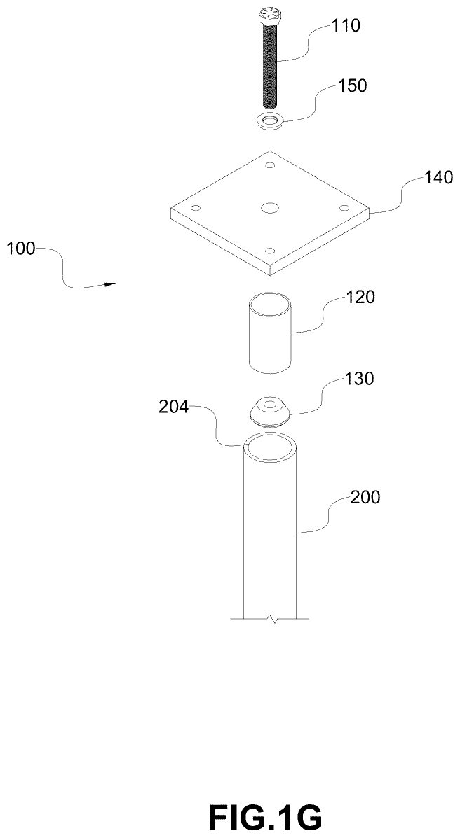

As illustratively shown in FIGS. 1A-1G, the shaft connector 100 can include at least one engagement member 110, at least one expansion body 120, at least one displacement body 130, and can optionally further include a loading body 140, and can optionally include an engagement support member 150.

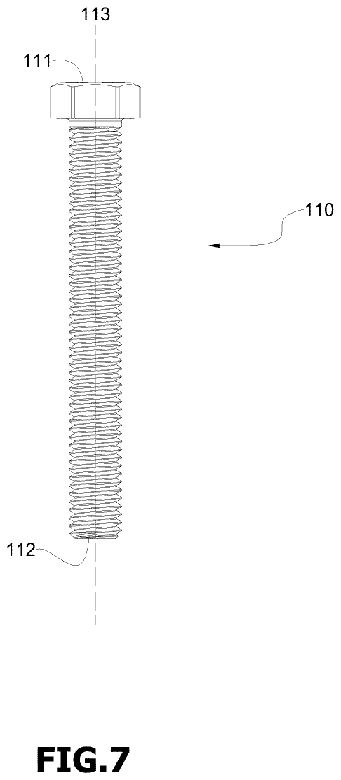

In an exemplary embodiment, as illustratively shown in FIG. 7, engagement member 110 can include an engagement member first end 111, an engagement member second end 112, and an engagement member longitudinal axis 113. The engagement member can be a threaded rod, bolt, or similar elongate structure configured to transmit axial force between the expansion body and displacement body, for example and not in limitation. The engagement member may further optionally include a head portion, a tool interface, or a locking feature.

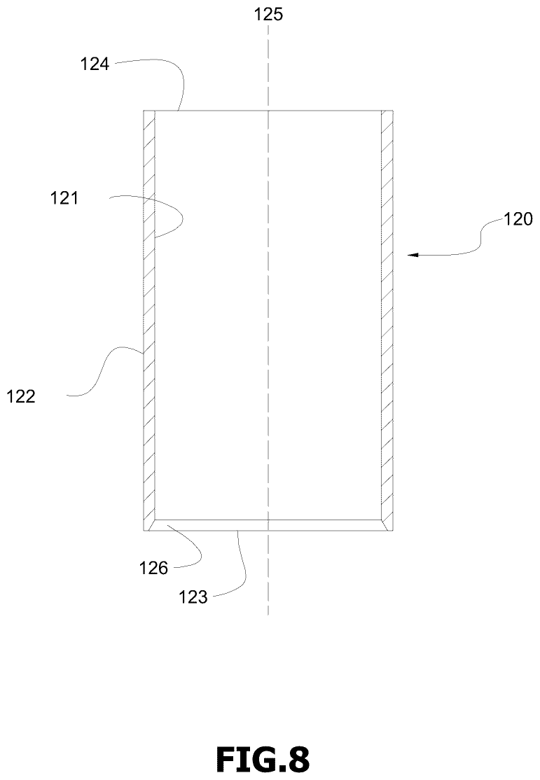

In another exemplary embodiment, as illustratively shown in FIGS. 1A-1G, FIG. 8, FIG. 12, and FIG. 13, expansion body 120 can include an expansion body inner surface 121, which is configured to receive at least a portion of the engagement member 110. The expansion body can also include an expansion body outer surface 122 configured to be at least partially positioned within shaft 200. The expansion body can further include a first expansion body end 123 and a second expansion body end 124 positioned along the expansion body longitudinal axis 125.

Notably, expansion body second end 124 can include one or more deformation surfaces 126, which may be configured to deform under pressure from displacement body 130, as described further herein. In an exemplary aspect, the deformation surface 126 may include a chamfered, slotted, ribbed, or flexible section that radially expands outward when axially compressed by displacement body 130, for example and not in limitation. The expansion body may be configured to change its shape via at least one of the displacement body and loading body 140 in a manner that can facilitate a mechanical interface to the shaft 200 and may optionally allow at least a portion of the expansion body outer surface 122 to deform complementary to the shape of the shaft inner surface 202. Said deformation may optionally be configured to form at least one complete ring of engagement between the expansion body and the shaft inner surface that is on one or more planes P perpendicular to at least one of the shaft longitudinal axis 201 and the displacement body longitudinal axis 135. As used herein, the term ‘deformation surface’ and ‘deformation portion’ may be used interchangeably and refer to any portion of the expansion body that undergoes a shape change under force from at least one of the displacement body 130, engagement body 110, shaft 200, and loading body 140.

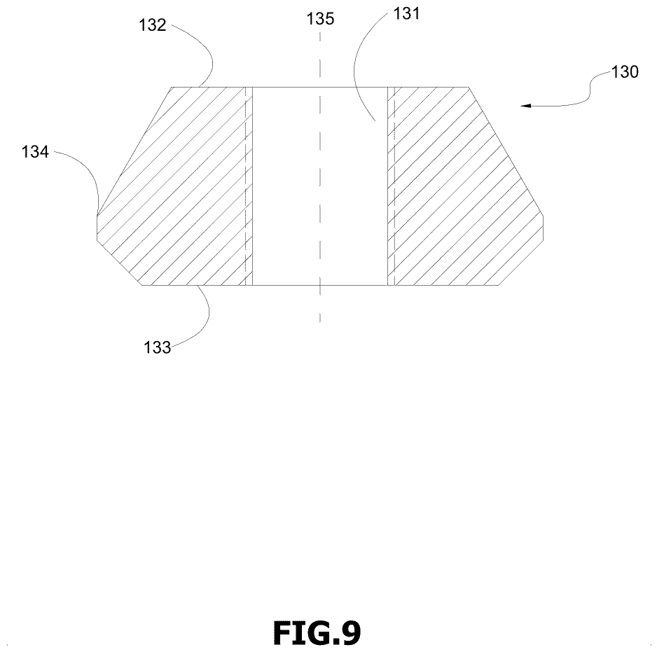

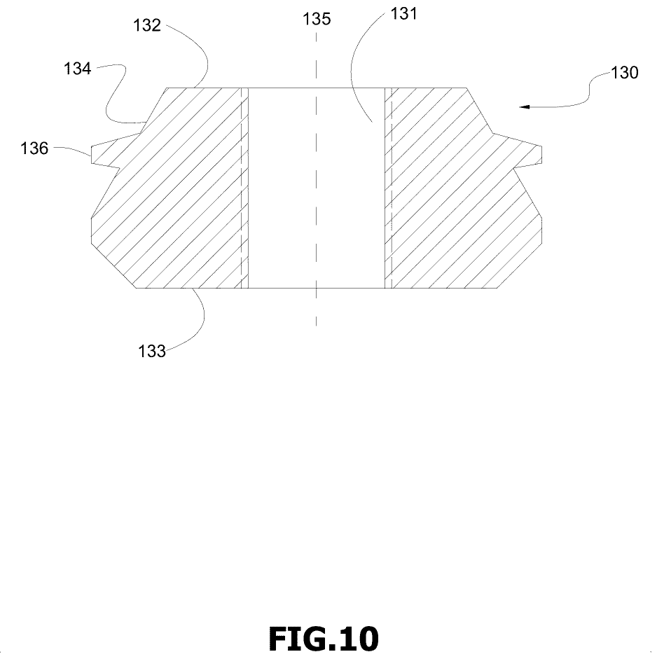

In another exemplary embodiment, as illustratively shown in FIGS. 9-10 and FIG. 12, displacement body 130 can include a displacement body inner surface 131, a displacement body first end 132, a displacement body second end 133, and a displacement body longitudinal axis 135. The displacement body inner surface 131 can be shaped to receive and or align at least a portion of the engagement member 110. The displacement body can also include a displacement body expansion surface 134 positioned between the first and second ends and configured to interface with at least one of the expansion body deformation surface 126, expansion body inner surface 121 and expansion body outer surface 122. In an exemplary embodiment, the displacement body expansion surface 134 can further include one or more secondary engagement surfaces 136 configured to interact with an expansion body 130 to facilitate use of the shaft connector, including but not limited to providing secondary engagement rings to the shaft inner surface 204, facilitating alignment of at least two of the displacement body, expansion body, shaft, and engagement member, and providing a void for the displaced expansion body material during the deformation process, for example and not in limitation.

In another exemplary embodiment, as illustratively shown in FIG. 1F, the expansion surface 134 of displacement member 130 can be engaged fully within expansion body 120 and cause the expansion body to deform inward, towards the longitudinal axis of at least one of the expansion body 120, displacement body 130, engagement member 110 and shaft 200, and thereby positively capture the displacement body and optionally permit the removal of engagement member 110 while maintaining the mechanical connection of the shaft connector 100 to the shaft.

Notably, while the expansion body 120 and displacement body 130 are illustratively shown as having angled and or conical shapes at the point in which the two components interact, both the expansion body and displacement body, as well as the engagement member 110, loading body 140, and optional engagement support member 150 can have any functionally compatible shape or shapes.

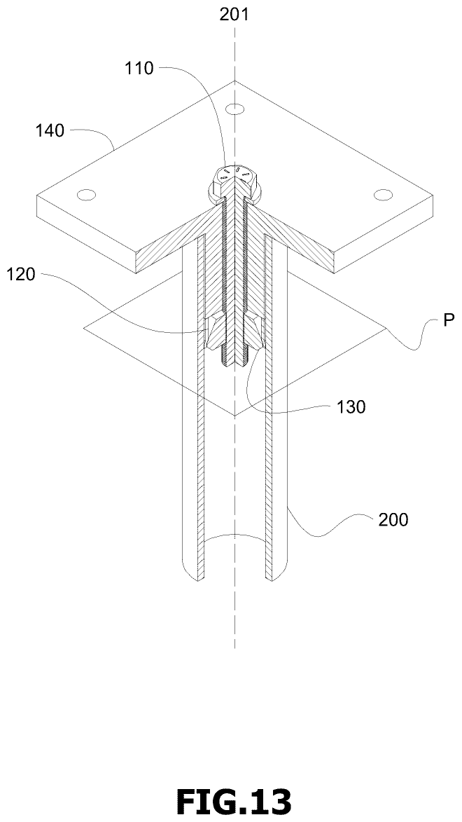

In exemplary embodiments, loading body 140 can be configured to be formed by the geometry of the shaft 200 at the shaft opening 204, or complementary shaped to fit at least partially within the shaft as illustratively shown in FIG. 13, for example and not in limitation. In this regard, the loading body 140 may be considered a form of axial reaction surface that receives compressive force from the displacement body 130 during connector 100 engagement. The reaction surface can enable axial loading through the expansion body 120, resulting in radial deformation due to mechanical interference with the shaft inner surface 202. While shown as a distinct component in some embodiments, the reaction surface may alternatively be formed integrally with the shaft geometry at or near the shaft opening 204. In all such configurations, the reaction surface can complete the axial load path between the engagement member 110 and displacement body 130.

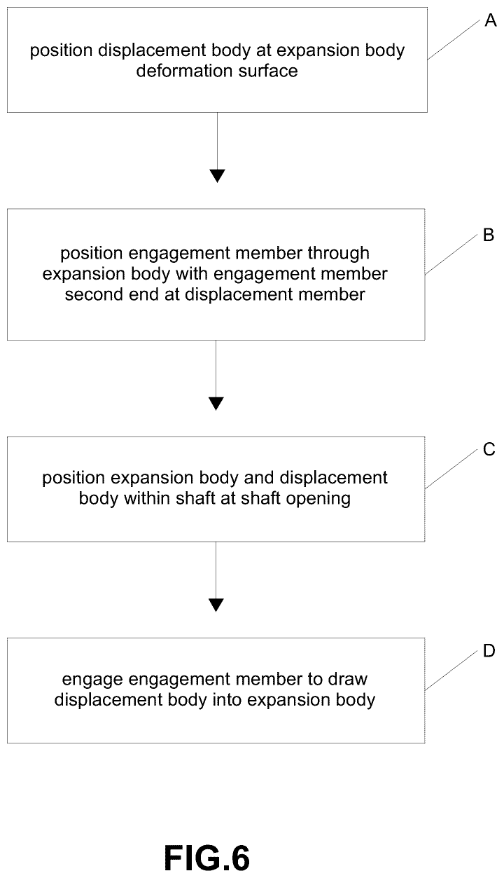

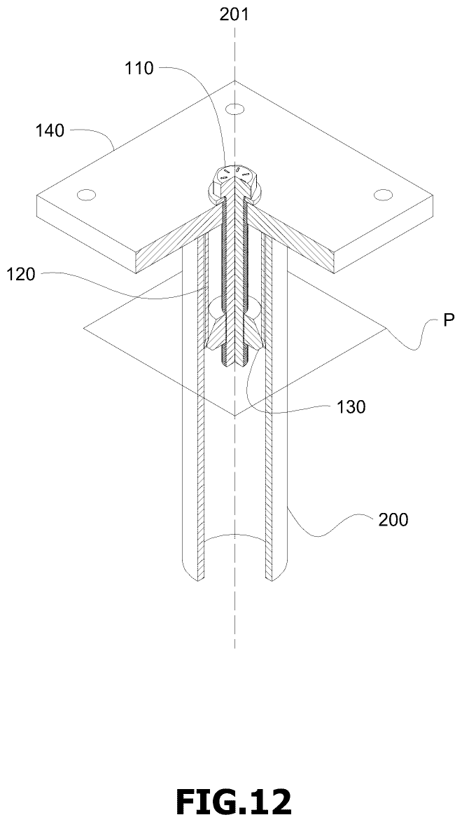

In an exemplary method of use, as illustratively shown in FIG. 1A-1G, FIG. 6, FIG. 12, and FIG. 13, displacement body 130 can be positioned at least partially within shaft 200 such that the displacement body first end 132 is inserted into expansion body 120, with expansion body 120 also positioned at least partially within the shaft and the expansion body second end 124 located proximate to shaft opening 204.

In a further exemplary method of use, engagement member 110 can then be inserted through shaft opening 204 such that the engagement member first end 111 engages with and or passes through expansion body 120, and the engagement member second end 112 is engaged with displacement body 130.

In yet another exemplary method of use, upon actuation (e.g., via rotation of a threaded engagement member or application of axial force, for example and not in limitation), engagement member 110 draws expansion body 120 and displacement body 130 toward one another along at least one of the shaft longitudinal axis 201 and engagement member longitudinal axis 113, causing expansion surface 134 of displacement body 130 to contact deformation surface 126 of expansion body 120. In response to this axial compression, the expansion body begins to deform, as described below.

In another exemplary aspect, continued axial displacement and compression between the displacement body and expansion body can cause the expansion body to undergo axial deformation, resulting in controlled radial expansion outward toward shaft inner surface 204. This deformation forms a mechanical interference or friction fit against the shaft inner surface creating a high-strength mechanical connection.

In an exemplary aspect, such a connection can be both load-bearing and reversible. Disengagement of engagement member 110 can release the radial deformation, permitting removal or repositioning of the shaft connector 100.

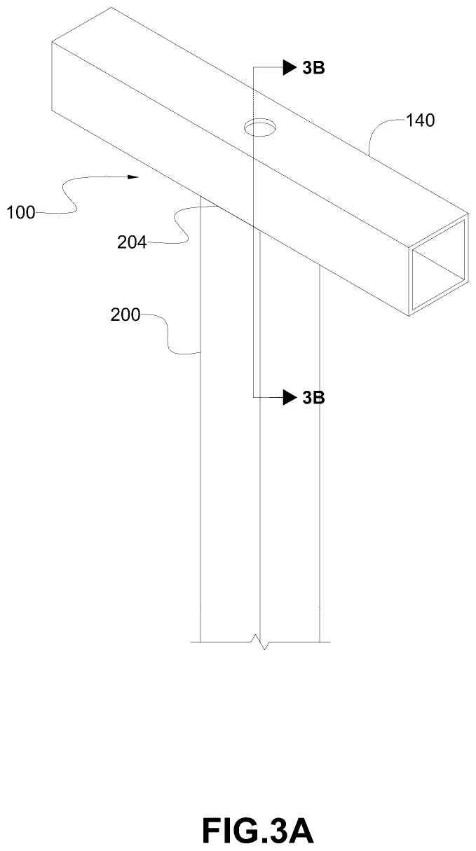

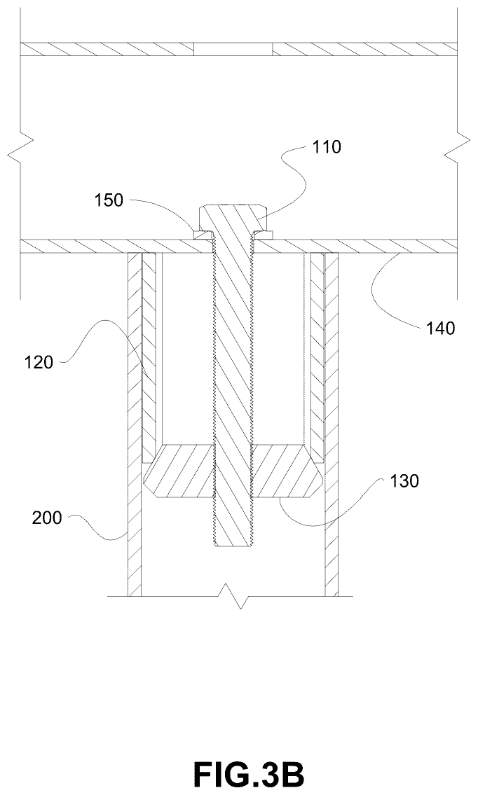

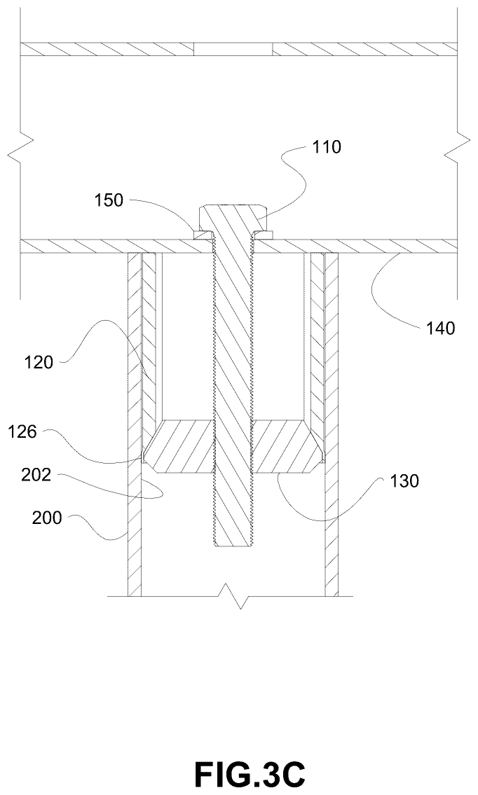

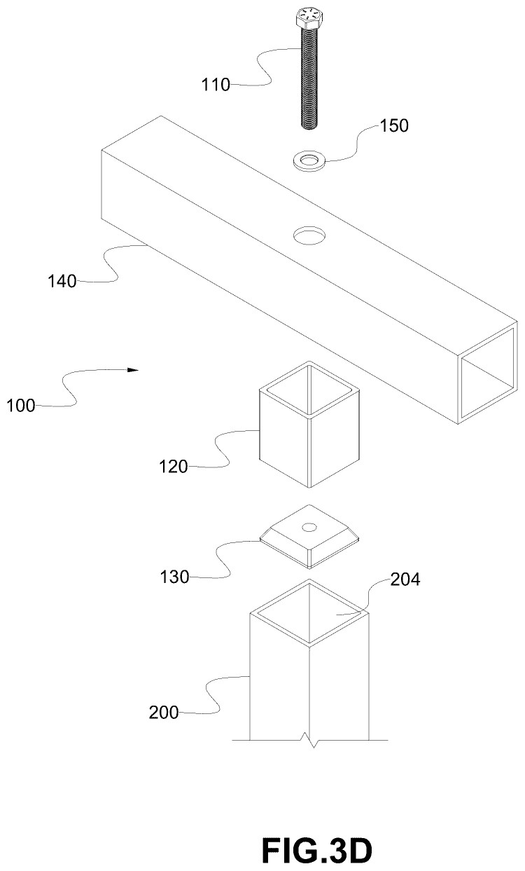

In further optional aspects, as illustratively shown in FIG. 1G and FIG. 3D, an expansion body 120 can be configured to be complementarily shaped to the inner surface of shaft 200. For example, and not in limitation, expansion body 120 can be configured with a generally circular outer surface for shafts with circular cross-sections, or a rectangular or polygonal outer surface for shafts with corresponding cross-sectional shapes.

In still another exemplary aspect, expansion body 120 and displacement body 130 may be formed from a flexible material, composite, polymeric, or elastomeric material configured to deform in a controlled manner under axial compression and to rebound upon release of the engagement force.

In yet another exemplary aspect, the engagement member 110 can be configured for tool-free engagement and disengagement. For example and not in limitation, the engagement member first end 111 can include a grip structure, such as a knurled or winged head, configured to be manually rotated by a user. Alternatively, the engagement member may include a quick-release interface, cam lock, or detent-based locking mechanism, which allows for axial actuation without rotation.

In an optional exemplary embodiment, shaft connector 100 can be configured for rapid deployment and removal from shaft 200 without the need for external tools. In such an embodiment, the engagement member 110 can be spring-loaded or tensioned, and can be configured to snap into a locked position upon insertion through shaft opening 204. Disengagement may be achieved via a release tab or button mechanism integrated into or adjacent to shaft opening 204, for example and not in limitation.

In a further exemplary aspect, the connector system can include one or more keyed alignment features to facilitate consistent positioning of shaft connector 100 within shaft 200. For example and not in limitation, expansion body 120 and/or displacement body 130 can include one or more alignment keys, ridges, or flats that engage with corresponding channels or surfaces within shaft 200. Notably, alignment keys, and similar configurations can be utilized to control undesired torque rotation within the shaft interior, and limit the applied torque to the shaft connector, for example and not in limitation.

In another exemplary configuration, shaft connector 100 can be used in load-transmission applications where both axial and torsional loads are applied to or transferred through the shaft. In such applications, the engagement between the expansion body and shaft inner surface 202 may be enhanced via optional surface features, including but not limited to: serrations, knurling, protrusions, high-friction coatings, or compliant interfaces such as elastomeric liners or sleeves.

In further optional exemplary aspects, connector 100 can include a secondary retention feature, such as a locking collar, clip, or secondary expansion sleeve, configured to engage shaft opening 204 or the external surface of shaft 200. This feature may act as a safety mechanism or redundant restraint system to prevent axial pull-out in the event of primary interface failure.

In another embodiment, connector 100 may be used in conjunction with structural adhesives, thermal expansion sleeves, or magnetically-responsive materials to enhance mechanical locking force and/or allow reversible engagement under controlled environmental or stimulus conditions (e.g., heat or magnetism).

In still another exemplary aspect, shaft connector 100 may be configured for use in a plurality of applications, including but not limited to: structural frameworks, medical devices (e.g., orthopedic implants), aerospace assemblies, modular scaffolding systems, furniture assembly, and sports equipment.

In yet another optional embodiment, shaft connector 100 may include integrated sensors or telemetry systems configured to monitor engagement force, strain, torque, or installation status. For example and not in limitation, an electronic strain gauge or RFID tag can be embedded within expansion body 120 or engagement member 110 to communicate the state of engagement to a user or external monitoring system.

In one exemplary use case, the shaft connector can be configured to secure a structural cap, bracket, or similar component to a helical pile shaft. In such an installation, the helical pile is first driven into the ground to a specified depth. After installation, the exposed portion of the helical pile is cut to a desired length. Following pile trimming, the shaft connector is inserted into the open end 204 of the pile shaft in accordance with the method described herein.

In additional optional aspects, the materials of construction for the expansion body 120, displacement body 130, and engagement member 110 can be independently selected from any functionally compatible materials, such as: high-strength aluminum alloys, stainless steels, carbon fiber composites, engineering polymers (e.g., PEEK, Delrin), elastomers, or hybrid layered structures.

In a particular embodiment, expansion body 120 can be formed from a spring-tempered stainless steel with longitudinal slots to allow for controlled outward deformation, while displacement body 130 can be formed from anodized aluminum with a tapered or radiused expansion surface 134 to maximize surface engagement efficiency.

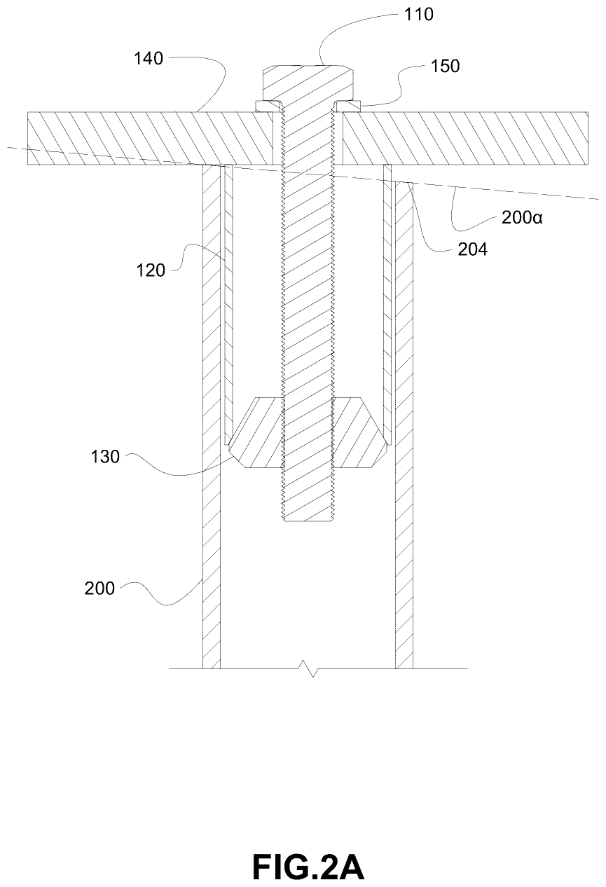

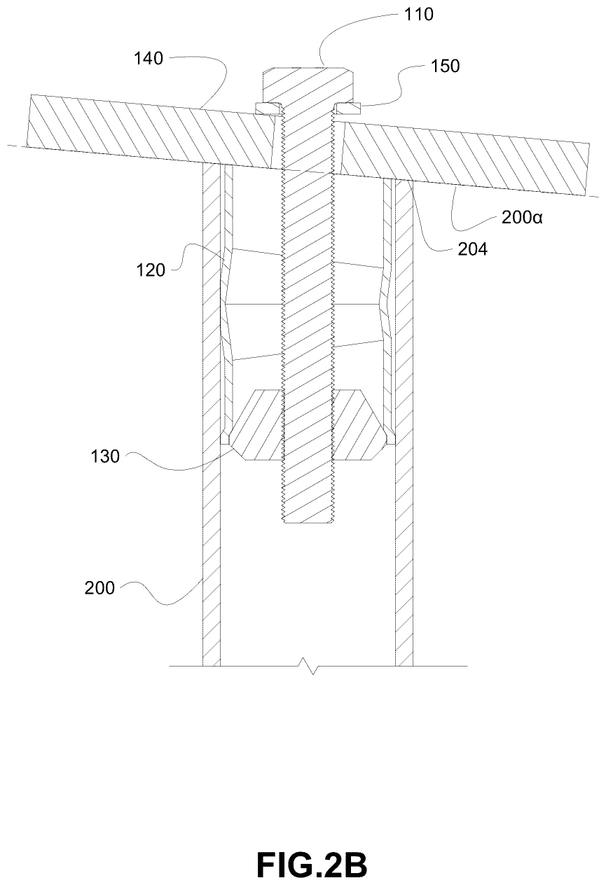

In another exemplary embodiment, expansion body 120 can be formed from a material that is softer or more malleable than at least one of shaft 200 or displacement body 130. For example and not in limitation, expansion body 120 can be formed from aluminum, brass, polymeric composites, or other ductile metals or materials, while shaft 200 and/or displacement body 130 can be formed from harder materials such as hardened steel, titanium, or reinforced composites. In such an embodiment, as engagement member 110 draws displacement body 130 into expansion body 120, the expansion surface 134 of displacement body 130 deforms the softer expansion body deformation surface 126 outward against the harder shaft inner surface 202. This controlled deformation allows the expansion body to conform more completely to irregularities in the shaft inner surface and distribute load more evenly, while also minimizing potential damage to the shaft or displacement body during installation and removal. Notably, as illustratively shown in FIGS. 2A-2B, such material configurations can further allow the shaft connector to function on shafts having irregular, or angled cuts 200 α, wherein the expansion member can have secondary deformation upon shaft engagement, allow for self-centering of one or more of the components of the shaft connector to the shaft and can further provide additional points of engagement to the shaft 200, for example and not in limitation. Further notably, said deformation of the expansion body can be both outward towards the shaft inner surface 204 and inward, towards the displacement member, for example and not in limitation. Additionally, the displacement body can be configured to also deform to at least one of the shaft inner surface 202 and expansion body 120.

In further aspects, the difference in material hardness can be selected to provide a mechanical “fuse” function, wherein the expansion body plastically deforms in overload conditions to protect other system components from failure. Additionally, the use of a softer expansion body material can allow for cold-flow or embedding into surface textures of shaft 200 to enhance retention without requiring abrasive surface treatments or adhesives.

Therefore, it will be apparent to one of ordinary skill in the art that the manner of making and using the claimed invention has been adequately disclosed in the above-written description of the exemplary embodiments and aspects. It should be understood, however, that the invention is not necessarily limited to the specific embodiments, aspects, arrangement, and components shown and described above, but may be susceptible to numerous variations within the scope of the invention. For example, while the present invention is illustratively shown used with a round helical piling shaft, the shaft connector can be configured for use with any shaped shaft and in applications outside of helical pilings, including rectangular shafts on stairs stringers, roof mounted stub-ups, etc. Further, while engagement member 130 is generally shown to be a hex head bolt, said engagement member may be provided with any functionally compatible structure to the extent desired.

Therefore, the specification and drawings are to be regarded in an illustrative and enabling, rather than a restrictive sense.

Accordingly, it will be understood that the above description of the embodiments of the present invention are susceptible to various modifications, changes, and adaptations, and the same are intended to be comprehended within the meaning and range of equivalents of the appended claims.

Therefore I claim:

1. A load bearing shaft connector configured to engage a shaft having a shaft inner surface, a shaft longitudinal axis, and at least one shaft opening positioned along the shaft longitudinal axis, the load bearing shaft connector comprising:
At least one engagement member, having an engagement member first end and an engagement member second end;
At least one expansion body, having an expansion body inner surface configured to accept at least a portion of the at least one engagement member, an expansion body outer surface configured to facilitate positioning of the expansion body at least partially within the shaft, an expansion body longitudinal axis, an expansion body first end positioned along the expansion body longitudinal axis, and an expansion body second end positioned along the expansion body longitudinal axis, and an expansion body deformation surface positioned at the expansion body second end;
At least one displacement body, having a displacement body inner surface being configured to accept at least a portion of the at least one engagement member, a displacement body longitudinal axis, a displacement body first end configured to fit at least partially within the at least one expansion body and positioned along the displacement body longitudinal axis, a displacement body second end configured to fit at least partially within the shaft and positioned along the displacement body longitudinal axis, and a displacement body expansion surface positioned between the first displacement body end and second displacement body end;
wherein when the expansion body first end of the at least one expansion body is at least partially positioned within the shaft, and the expansion body second end of the at least one expansion body is positioned towards the shaft opening, and the displacement body first end of the at least one displacement body is at least partially positioned within the at least one expansion body, and the displacement body expansion surface of the at least one displacement body is positioned at the expansion body deformation surface of the at least one expansion body, and with the at least one engagement member first end positioned at the at least one expansion body first end, and with the at least one engagement member second end positioned at the at least one displacement body, and as the at least one engagement member draws the at least one expansion body and the at least one displacement body axially toward each other, thereby applying an axial compressive force such that the displacement body expansion surface deforms the expansion body deformation surface to the shaft inner surface and applies a sufficient force to provide a mechanical connection of the load bearing shaft connector to the shaft.

2. The load bearing shaft connector according to claim 1, wherein the shaft connector is configured to engage a shaft having an inner surface forming a circular shape.

3. The load bearing shaft connector according to claim 1, wherein the shaft connector is configured to engage a shaft having an inner surface forming a square shape.

4. The load bearing shaft connector according to claim 1, further comprising at least one loading body positioned at the shaft opening.

5. The load bearing shaft connector of claim 1, wherein the shaft is a helical pile shaft.

6. The load bearing shaft connector of claim 1, further comprising a second expansion body and a second displacement body, wherein the engagement member is configured to draw the first and second expansion bodies and the first and second displacement bodies axially toward one another to form two mechanical connections within the shaft.

7. A method of using a load bearing shaft connector to engage a shaft having a shaft inner surface, a shaft longitudinal axis, and at least one shaft opening positioned along the shaft longitudinal axis, with the load bearing shaft connector comprising at least one engagement member, having an engagement member first end and an engagement member second end,
At least one expansion body, having an expansion body inner surface configured to accept at least a portion of the at least one engagement member, an expansion body outer surface configured to facilitate positioning of the expansion body at least partially within the shaft, an expansion body longitudinal axis, a first expansion body end positioned along the expansion body longitudinal axis, and an expansion body second end positioned along the expansion body longitudinal axis, and an expansion body deformation surface positioned at the expansion body second end,
At least one displacement body, having a displacement body inner surface being configured to accept at least a portion of the at least one engagement member, a displacement body longitudinal axis, a displacement body first end configured to fit at least partially within the at least one expansion body and positioned along the displacement body longitudinal axis, a displacement body second end configured to fit at least partially within the shaft and positioned along the displacement body longitudinal axis, and a displacement body expansion surface positioned between the displacement body first end and displacement body second end, the method comprising:
A. positioning the displacement body first end of the at least one displacement body at least partially within the at least one expansion body, such that the displacement body expansion surface of the displacement body is positioned at the expansion body deformation surface of the expansion body;
B. positioning the engagement member first end of the at least one engagement member at the expansion body first end of the at least one expansion body, and the engagement member second end of the engagement member at the at least one displacement body;
C. positioning the at least one expansion body and the at least one displacement body at least partially within the shaft, with the expansion body second end of the at least one expansion body positioned toward the shaft opening;
D. engaging the at least one engagement member to draw the at least one expansion body and the at least one displacement body axially toward each other thereby applying an axial compressive force such that the displacement body expansion surface deforms the expansion body deformation surface to the shaft inner surface and applies a sufficient force to provide a mechanical connection of the load bearing shaft connector to the shaft.

8. The method of using a load bearing shaft connector according to claim 7, wherein the shaft connector is configured to engage a shaft having an inner surface forming a circular shape.

9. The method of using a load bearing shaft connector according to claim 7, wherein the shaft connector is configured to engage a shaft having an inner surface forming a square shape.

10. The method of using a load bearing shaft connector according to claim 7, wherein the shaft connector further comprises at least one loading body positioned at the shaft opening.

11. The method of using a load bearing shaft connector according to claim 7, wherein the shaft connector is configured to engage a shaft that is a helical pile shaft.

12. The method of using a load bearing shaft connector according to claim 7, further comprising positioning a second expansion body and a second displacement body within the shaft, and actuating the engagement member to simultaneously deform both expansion bodies to form two mechanical connections.

13. The method of using a load bearing shaft connector according to claim 7, wherein the shaft comprises an angled cut at the shaft opening.

14. A load bearing shaft connector configured to engage a shaft having an inner surface, a longitudinal axis, and at least one shaft opening, the load bearing shaft connector comprising:
an expansion body having at least one deformable portion and configured to be positioned at least partially within the shaft, a displacement body configured to be positioned within the shaft and to contact the expansion body;
an engagement member extending through the shaft opening and configured to draw the expansion body and the displacement body axially toward one another along the longitudinal axis of the shaft, thereby applying an axial compressive force to the deformable portion of the expansion body to deform it against the inner surface of the shaft and thereby form a mechanical connection.

15. The load bearing shaft connector according to claim 14, wherein the shaft connector is configured to engage a shaft having an inner surface forming a circular shape.

16. The load bearing shaft connector according to claim 14, wherein the shaft connector is configured to engage a shaft having an inner surface forming a square shape.

17. The load bearing shaft connector of claim 14, further comprising at least one loading body positioned at the shaft opening.

18. The load bearing shaft connector of claim 14, wherein the shaft is a helical pile shaft.

19. The load bearing shaft connector of claim 14, further comprising a second expansion body and a second displacement body, wherein the engagement member is configured to draw the first and second expansion bodies and the first and second displacement bodies axially toward one another to form two mechanical connections within the shaft.

20. The load bearing shaft connector of claim 14, wherein the shaft opening comprises an angled cut relative to the shaft longitudinal axis.
